(19) United States
(12) Patent Application Publication
(10) Pub. No.: US 2021/0334704 A1
(43) Pub. Date: Oct. 28, 2021

(54) Method and System for Operating a Technical Installation with an Optimal Model

(71) Applicant: Siemens Aktiengesellschaft, Muenchen (DE)

(72) Inventors: Daniel SCHALL, Hollabrunn (AT); Thomas HIEßL, Wien (AT); Jana KEMNITZ, Wien (AT)

(21) Appl. No.: 17/237,157

(22) Filed: Apr. 22, 2021

(30) Foreign Application Priority Data
Apr. 23, 2020 (EP) 20171009

(51) Int. Cl. G06N 20/00; G06K 9/62; H04L 12/24

(52) U.S. Cl. CPC G06N 20/00; H04L 41/16; G06K 9/6215; G06K 9/6256

(57) ABSTRACT

A method for operating a technical installation with an optimal model, wherein the installation forms part of a system with a first technical installation and at least one second technical installation, where each installation includes a control apparatus and a connected technical device, and where the system also includes a server with a memory.

### BACKGROUND OF THE INVENTION

### 1. Field of the Invention

The invention relates to an installation for operation with an optimal model including a control apparatus with a memory, a technical device, a server with a memory (MEM), a method and system for operating the technical installation with the optimal model, where the installation forms part of the system with a first technical installation and at least one second technical installation, each installation including a control apparatus with a memory and a connected technical device.

### 2. Description of the Related Art

Federated learning (FL), which is also known as collaborative learning, is a machine learning technique (ML) that trains an algorithm across multiple decentralized edge devices or servers holding local data samples without exchanging the data samples thereof.

This known approach contrasts with conventional centralized machine learning techniques in which all data samples are uploaded to one server and with more traditional decentralized approaches that often assume that local data samples are identically distributed.

Federated learning allows multiple actors to produce a common comprehensive machine learning model without sharing data, thus allowing critical issues such as data protection, data security, data access rights and access to heterogeneous data to be addressed.

Federated learning aims to train a machine learning algorithm, for example, deep neural networks, on multiple local datasets contained in local nodes without exchanging data samples.

The general principle consists in training local models on local data samples and exchanging parameters, such as the weights of a deep neural network, between these local models with a specific frequency in order to create a global model.

Federated learning algorithms can use a central server that coordinates the different steps of the algorithm and functions as a reference clock or they can be peer-to-peer if no such central server is present. If there is no peer-to-peer, then a federated learning process can be divided into multiple rounds each consisting of four general steps.

The main difference between federated learning and distributed learning lies in the assumptions made about the properties of the local datasets because distributed learning is originally aimed at parallelization of computer power while federated learning is originally aimed at the training of heterogeneous datasets.

While distributed learning is also aimed at training one single model on multiple servers, it is frequently assumed that the local datasets are identically distributed and are of approximately the same length. None of these hypotheses have been made for federated learning. Instead, the datasets are usually heterogeneous and their lengths can span several orders of magnitude.

To ensure optimal task performance of a final central machine learning model, federated learning relies on an iterative process divided into an atomic set of client-server interactions designated a federated learning round.

Each round of this process consists in transmitting the current global model state to participating nodes, training local models on these local nodes to produce a series of potential model updates at each node and then aggregating these local updates to form one single global update and applying it to the global model.

In the methodology below, a central server is used for this aggregation, while local nodes perform local training depending on the central server's instructions. However, other strategies lead to the same results without central servers in a peer-to-peer approach using gossip methods.

For initialization in an iteration method, a statistical model (for example, such as linear regression, neural network, or boosting) is selected in order to be trained on local nodes and initialized. Nodes are activated and wait for the central server to take over calculation tasks.

With iterative training, the following steps are executed for multiple iterations of “federated learning rounds”:
Selection: A fraction of the local nodes is selected in order to start training local data. They all acquire the same current statistical model from the current server. Other nodes wait for the next federated round.
Configuration: The central server initiates selected nodes to train the model on their local data in a predefined manner, such as for some batch updates of gradient descent.
Reporting: Each node returns the locally learned incremental model updates to the central server. The central server aggregates all the results and stores the new model. It also handles errors such as a loss of connection with a node during the training. The system returns to the selection phase.
Termination: When a prespecified termination criterion, such as, for example, a maximum number of rounds or local accuracies that are higher than a target, is met, the central server orders the end of the iterative training process. The central server may contain a robust model trained on multiple heterogenous data sources.

However, in the prior art, it may be the case in certain applications that even the jointly trained models have insufficient accuracy.

### SUMMARY OF THE INVENTION

It is the object of the invention to provide a method and system that overcome the foregoing drawbacks of the prior art and further improve the accuracy of FL models.

This and other objects and advantages are achieved in accordance with the invention by a method for operating a technical installation with an optimal model, wherein the following method steps are executed:
Q1) creating a basic device model with respect to at least one of technical device,
Q2) distributing a basic device model to a first and at least one second control apparatus,
Q3) creating, training and storing a first device model by the first control apparatus and at least one second device model by the at least one second control apparatus, in each case based on the basic device model,
Q4) providing the first and the at least one second device model to a server and storing the first and the at least one second device model in a model memory of the server,
Q5) loading and providing at least those device models that are not already present in the control apparatus to the corresponding control apparatus,
Q6) applying the device models provided in step Q5) to the respective control apparatus and determining a respective similarity function with respect to the first control apparatus and the first similarity model to the at least one second control apparatus and determining a respective similarity function with respect to the at least one second control apparatus,
Q7) transferring the respective similarity functions to the server,
Q8) forming at least one client group and producing a respective group model by federated learning within the client group by applying the similarity functions by the server, and
Q9) selecting and loading an operation model from the at least one group model for an installation and providing the operation model to the control apparatus thereof and actuating the device using the selected operation model as the optimal model.

A basic device model should be understood to be an ML model for calculating similarity (“similarity model skeleton”).

The basic device model, such as an autoencoder, is produced taking into account the clients' data structure without requiring knowledge of the data content.

The basic device model can then, for example, be received by the first control apparatus and trained on the basis of the specific client data, such as by adapting weights of the autoencoder via a backpropagation algorithm known to the person skilled in the art.

A basic device model can describe a general operating behavior of a device, for example, without taking account of a special operating environment or a special parameter combination during operation.

A device model can, for example, describe a specific operating behavior of the device, for example, in a special operating environment or taking into account a special parameter combination during operation. Hence, the first and the second device model can, for example, be enriched by further model parameters compared to the basic device model or also be based on a larger training dataset.

An operation model can map influential variables of the operation of an installation in an ML model, wherein this can take place on the basis of a basic device model, i.e., for example, the underlying basic device model can be expanded by current parameters.

A group model can, for example, be derived or formed from multiple device models, such as by expanding parameters or parameter combinations or by applying modified abstraction functions or modified similarity functions.

The selection of the operation model in step Q9 can occur because, for example, a user defines a target parameter for a model or by using the method in accordance with the invention to obtain an improved model for a selected installation from a group model. This parameter or the selection of an installation can be used as the basis for deriving a corresponding criterion that allows a corresponding selection of a group model. A model is selected from the set of available group models, such as by applying the named criterion or by selecting a dedicated installation for which an improved model, i.e., an optimal model, is to be ascertained by means of federated learning.

In a further step, the device model can be specifically derived for a second control apparatus and used to calculate the similarity with respect to the first control apparatus.

The model or client group can, for example, be defined based on particularly important key operating figures of the device, such as temperature or pressure, the ambient conditions or user parameters.

A client group can have multiple clients with respective installations, in each case including a technical device, but only has one model for the installation for the device.

In the simplest case, the similarity function can be a scalar, i.e., a similarity value. Accordingly, on the formation of the similarity function, a numerical similarity value between two similarity models can be determined by applying a similarity method, as specified in step Q6).

The similarity function can also include more than one similarity value, for example, different similarities for each different operating mode of the device, which can be described with the aid of the similarity function.

In principle, it is not necessary for the assets only to include devices of the same design or only devices with the same operating behavior. However, it is clear that the models can be all the more efficiently improved if similar devices are taken into account in the method in accordance with the invention.

The similarity of devices can relate to structural or even operative features. Similarity can be determined using individual parameters as well as overall characteristics, such as the operating temperature, mechanical vibrations or the power consumption of an individual component or the entire system.

For example, electric motors, pumps, milling machines, production machines, industrial installations, vehicles may each be similar to one another in that they have the same configuration, are operated in a comparable operating environment or exhibit the same performance of individual components or a system.

In embodiment of the invention, a further step is executed after step Q7). That is, Q7a) calculating at least one centroid model on the basis of a federated averaging method using the similarity functions, and in step Q8) at least one centroid model is taken into account when forming at least one group model.

During the creation of group models, a centroid model can be used to weight operation models that are closer or more similar to the centroid model more strongly. This can further improve accuracy.

Alternative models to a basic device model are available that can include additional features, parameters or characteristic quantities of the device. This enables a more accurate ML model to be offered for a specific feature, for example, when adding a further new device.

In another embodiment of the invention, a further step is executed after step Q7). That is, Q7b) storing the similarity functions in a similarity matrix. This can enable a quick search for similarities to be performed and a subset of the matrix to be determined particularly efficiently and quickly and used to form or use a model.

In principle, other data structures are also suitable for storing the similarity values or similarity functions, but the data can be processed particularly efficiently via the matrix.

In another embodiment of the invention, in step Q8) at least one weighting function is applied when forming the at least one group model. This makes it easy to aggregate data that is, for example, relevant in different ways depending on the application.

In a further embodiment of the invention, the basic device model is created by the server.

It is clear that the basic device model must be present before the method is started. New clients can access this basic device model. This enables a device model to be applied in a particularly simple way as a common starting point for further learning rounds.

In a further embodiment of the invention, the installation is connected to the control apparatus via a local network and connected to the server via a public network.

The method in accordance with the disclosed embodiments achieves a high degree of data protection because no device data is sent to the server, only model data. The device data can, for example, be protected by a firewall.

Nevertheless, it is possible for a common FL model to be trained and multiple devices connected to one another thereby in order to learn from one another.

In another embodiment of the invention, the at least one second installation is in each case connected to the respective control apparatus via a local network and in each case is connected to the server via a public network.

It is also an object of the invention to provide a system that is configured to execute the method steps according to the invention, where the system includes a control apparatus that is configured to execute the following method steps of:
R1) receiving a basic device model,
R2) creating, training and storing a first device model based on the basic device model,
R3) providing the device model via a first data interface,
R4) receiving at least one second device model that is not already present in the control apparatus via a second data interface,
R5) applying the at least one second device model received in step R4) to the control apparatus and determining a similarity function with respect to the first device model,
R6) providing the similarity function via a third data interface, and
R7) receiving an operation model that was formed by at least one group model by applying the similarity function via a fourth data interface and actuating the device using the operation model as the optimal model.

In a further embodiment of the invention, the first, second, third and/or fourth data interface is formed by a public network and the installation is connected to the control apparatus via a local network.

The method achieves a high degree of data protection because no device data is sent to the server, only model data. The device data can, for example, be protected by a firewall apparatus.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is described below with reference to an exemplary embodiment depicted in the attached drawings, in which:

FIG. 1 is a schematic illustration of a system architecture with an industrial device, which is controlled via an ML model in accordance with then invention;

FIG. 2 is a schematic view of two industrial edge devices each depicting a client in accordance with the invention;

FIG. 3 an exemplary embodiment of an apparatus in accordance with the invention;

FIG. 4 is an exemplary schematic illustration of the method in accordance with the invention;

FIG. 5 shows exemplary pseudocode in accordance with embodiment of the invention;

FIG. 6 shows exemplary pseudocode for forming cohorts in accordance with an embodiment of the invention;

FIG. 7 shows a further exemplary embodiment of pseudocode in accordance with the invention in the form; and

FIG. 8 is a flowchart of the method in accordance with the invention.

### DETAILED DESCRIPTION OF THE EXEMAPLARY EMBODIMENTS

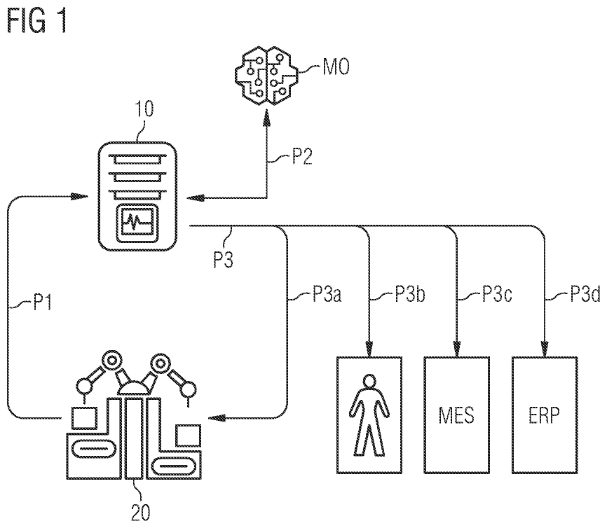

FIG. 1 shows a system architecture with an industrial device controlled via a machine learning (ML) model.

In order to avoid assets, such as devices, machines or installations being damaged during a production operation, ML models are trained to identify anomalies based on pre-recorded sensor data. In addition, these models are used in industrial buildings, for example, for industrial control systems, and called up to identify and classify anomalies. In this way, operators can be notified, the current process can be stopped or the production rate reduced.

In addition, changes to the production schedule can be initiated to avoid calling up the asset in question. Here, the production process takes account of redundant assets, if these are installed and have sufficient capacity. This can be implemented by interaction with manufacturing execution systems (MES). In addition, spare parts can be ordered automatically if the model classifies the problem and derives a solution with higher accuracy.

However, training ML models solely based on the data of one client, i.e., one single operator of an installation, can possibly result in anomaly identification and classification with a low degree of accuracy because these models only take into account patterns derived from incidents in that client's past.

FIG. 1 shows a client with an IoT device 10, such as a general technical device, such as an industrial installation, a robot, or a CNC milling machine, i.e., an asset.

The device 10 is connected to an edge apparatus 20 that can be used to access an ML model M0 provided, for example, by a computing apparatus with a memory.

The edge apparatus 20 executes the following process steps:
P1 First, data from the device 10 is acquired, edited and made available to the edge apparatus 20.
P2 This is followed by anomaly detection by comparing the data with the ML model M0.
P3 This is then followed by control of the device 10 derived from step P2.
   P3a On the identification of a production problem a process step, for example, “stop” or “reduce” the current processing, can be triggered to intervene in the ongoing method.
   P3b Furthermore, an alarm can be output to an operator.
   P3c Moreover, production can be rescheduled as a result of the problem by means of a manufacturing execution system (MES).
   P3d Moreover, the ordering of a spare part can be initiated with the aid of an ERP (enterprise resource planning) system.

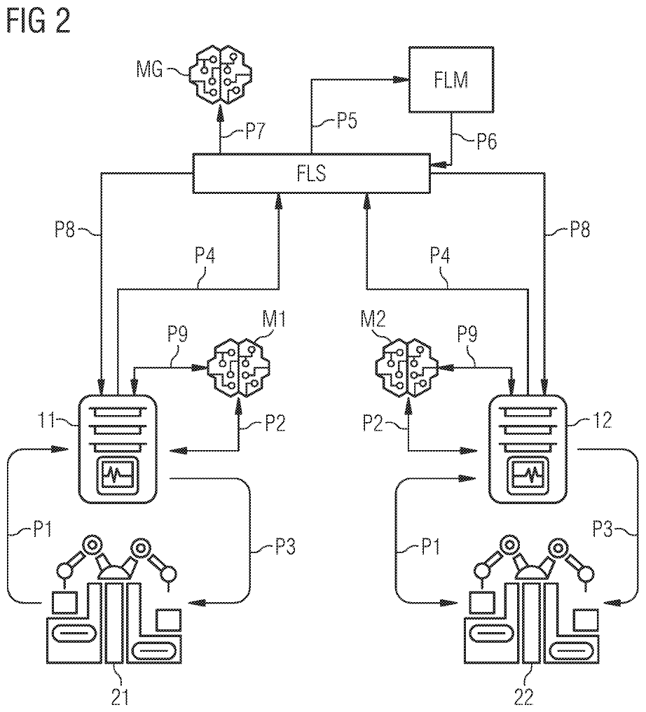

FIG. 2 is a schematic view of two industrial edge devices 11 and 12 each representing a client. The aim is to correctly classify anomalies in the respective production installation, where the installations are mapped by corresponding ML models P2, P3 and stored in computing apparatuses with respective memories that can be accessed by the edge devices 11, 12.

The following now explains process steps P4 to P9, which supplement FIG. 1.

The control and data flow can be described with process steps P1 to P3 and corresponds to the original anomaly classification process described in the previous section.

This process is now expanded by an additional model update workflow with the process steps P4 to P9 that can be executed in parallel to the process steps P1 to P3.

P4: By modeling and evaluating metrics, the current ML model, such as neural network weights, and metadata such as the length of the dataset and the number of different classes, are uploaded to a server 30. In subsequent process iterations, rating metrics are also uploaded, where account is taken of the accuracy of the classifier, for example, which is evaluated in a locally held validation dataset.

P5: Distribution of models and data occurs with which an industrial federated learning (IFL) group manager FLM is called up by the IFL server FLS in order to produce groups based on the distribution of the classes of the participating clients. Clients with a similar class distribution are placed in the same group. This can, for example, occurs via clustering using distance measures focused on similarity and differential data distributions. In addition, the group is supported by a configurable number of collaborators from other groups. These collaborators are identified in order to contribute knowledge based on the classification of classes that are less present in the respective group.

P6: The resulting group configuration is returned to the IFL server in order to aggregate the model parameters of group members and collaborators.

P7: The updated global ML model MG for all the groups is stored by updating aggregates.

P8: The global ML model MG is forwarded to the clients as a model update.

P9: Renewed training with updated models M1, M2 enables the respective global model MG to be used by the client to initialize local training on the client.

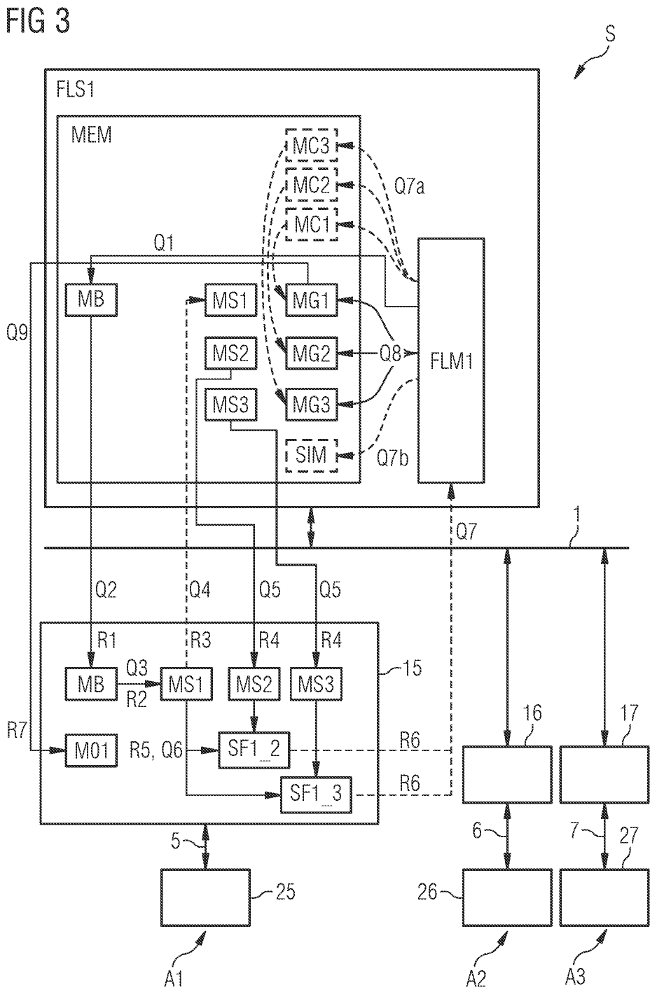

FIG. 3 is a schematic view of an exemplary embodiment of the invention in the form of an apparatus for operating each technical installation A1-A3 with a respective optimal ML model.

The system S includes a first technical installation A1, a second technical installation A2 and a third technical installation A3.

Each installation A1, a2, A3 includes a control apparatus 15, 16, 17 with a memory and a technical device 25, 26, 27.

The system furthermore comprises a server FLS1 with a memory MEM.

The first, second and third installation A1, A2, A3 are each connected to the respective control apparatus 15, 16, 17 via a local network 5, 6, 7, and each connected to the server FLS1 via a public network 1.

Alternatively, the installations A1, A2, A3 could jointly form an industrial installation with multiple technical devices and could be connected to one another via a local network. Here, this industrial installation with the server FLS1 could be connected to the public network via a proxy apparatus, such as together with a firewall apparatus. In this example, the technical installations A1, A2, A3 are three clients with respective edge devices.

The edge devices 15, 16, 17 can access an ML model MB provided, for example, by a computing apparatus with a memory.

The following process steps are executed by the system:
Q1 Creating and storing a basic device model MB on the basis of a technical device.
Q2 Distributing the basic device model MB to the first, second and third edge apparatus 15, 16, 17 of the respective client.
Q3 Creating and training on the basis of the basic device model MB
   a first device model MS1 by the first edge apparatus 15,
   a second device model MS2 by the second edge apparatus 16 and
   a third device model MS3 by the third edge apparatus 17.
Q4 Providing the trained first, second and third device model MS1, MS2, MS3 to an IFL server FLS1 and storing in a model memory MEM of the IFL server FLS1.
Q5 Loading and providing
   the second and third similarity model MS2, MS3 to the first edge apparatus 15,
   the first and third similarity model MS1, MS3 to the second edge apparatus 16 and
   the first and second similarity model MS1, MS2 to the third edge apparatus 17.
Q6 Applying
   the second and third similarity model MS2, MS3 to the first edge apparatus 15 and determining respective similarity values SF1_2, SF1_3 with respect to the first edge device 15,
   the first and third similarity model MS1, MS3 to the second edge apparatus 16 and determining respective similarity values SF2_1, SF2_3 with respect to the second edge device 16,
   the first and second similarity model MS1, MS2 to the third edge apparatus 17 and determining respective similarity values SF3_1, SF3_2 with respect to the third edge device 17.

In the present exemplary embodiment, the similarity functions are each scalars, i.e. similarity values.
Q7 Transferring the respective similarity values SF1_2, SF1_3, SF2_1, SF2_3, SF3_1, SF3_2 to the IFL server FLS1.
Q7a Calculating at least one centroid model MC1, MC2, MC3 based on a federated averaging method using the similarity functions (SF1_2, SF1_3, SF2_1, SF2_3, SF3_1, SF3_2).

A centroid model MC1, MC2, Min each case represents a model with the greatest similarity within a group of similarity models-models MS1-MS3.
Q7b Storing the similarity values SF1_2, SF1_3, SF2_1, SF2_3, SF3_1, SF3_2 in a similarity matrix SIM.
Q8 Forming at least one client group and producing a respective group model MG1, MG2, MG3 by federated learning within the client group by applying the similarity values SF1_2, SF1_3, SF2_1, SF2_3, SF3_1, SF3_2 by the IFL server FLS1, where at least one centroid model MC1-MC3 is taken into account and at least one weighting function is applied to the respective group model MG1, MG2, MG3.
Q9 selecting and loading an operation model M01 from the at least one group model MG1, MG2, MG3 for an installation A1 and providing the operation models M01 to the control apparatus 15 thereof and actuating the device 25 using the selected operation model M01 as the optimal model.

The basic device model MB is created or provided by the server.

It is clear the model memory MEM can communicate with the server and, for example, can also be located in a cloud. The model memory MEM is assigned to the IFL server FLS1.

Group formation can be understood to mean a grouping or clustering of distributed FL clients according to similar data or datasets.

Groups can be formed with group-forming algorithms using similarity models that safeguard the data protection of the data or datasets used. Herein, an algorithm of this kind returns the similarity from the clients' control facilities.

This enables the FL process to share knowledge in suitable groups in order to improve accuracy.

Herein, the IFL server can execute known federated averaging algorithms for each group.

To establish a respective similarity of data between two clients A and B, or such as A1 and A2 in the above example, a similarity model can be introduced, such as an autoencoder, which is trained via data from a model B and to which data from a model A is applied to calculate the similarity therefrom.

This results in a reconstruction error, which is large if the data is not similar and small if it is similar. In other words, the two clients A and B are placed in the same group if they have a high degree of similarity.

The method is intended to enable optimal group formation, i.e., grouping of FL clients with similar data, in order to ensure improved accuracy within a group.

The following assumes a random group algorithm based on similarity measures or distance measures, such as hierarchical cluster algorithms with variants such as “SingleLinkage” or “CompleteLinkage”.

The grouping process can be executed in parallel to the FL process. Resulting groups can be used to trigger the reorganization of the FL process in order to execute subsequent learning rounds.

The similarity between two clients A and B can be described by the following relationship:

$$Similarity ( A , B ) = Similarity ( similarity model ( A ) , dataset ( B ) ) + Similarity ( similarity model ( B ) , dataset ( A ) )$$

where the first term is calculated at the client B where its dataset is present and the second term at the client A where its dataset is present.

In a further embodiment, the stacking system includes a plurality of unwinding or deflection rollers, where in each case one foil- or membrane-like material web can be continuously conveyed by one of the plurality of unwinding or deflection rollers.

For example, the reconstruction error can be calculated for an autoencoder similarity model:

$$Similarity ( A , B ) = 1 / Reconstruction error ( autoencoder ( A ) , dataset ( B ) ) + 1 / Reconstruction error ( autoencoder ( B ) , dataset ( A ) )$$

For an installation A1, A2, A3 in accordance with the invention for operation with an optimal model, the method steps provided for the respective control apparatus 15, 16, 17 are provided:
R1) corresponds to step Q2),
R2) corresponds to step Q3),
R3) corresponds to step Q4),
R4) corresponds to step Q5),
R5) corresponds to step Q6),
R6) corresponds to step Q7),
R7) corresponds to step Q9).

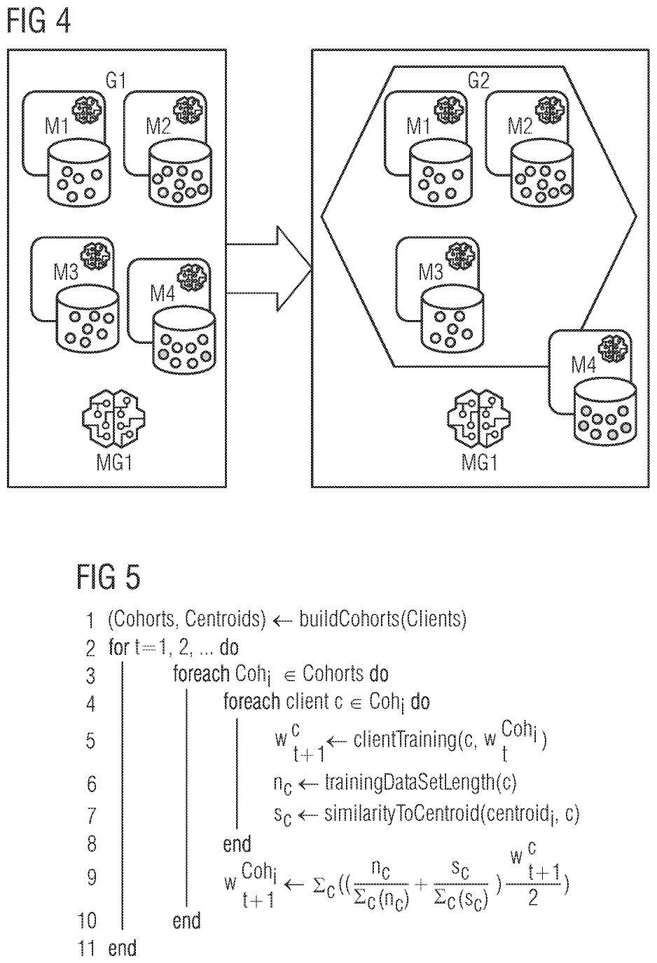

FIG. 4 is a schematic view of an example of a method with which data elements for a cohort are formed and as a result of which accuracy can be improved for a specific group.

Unlike the case in the prior art, in which group models M1, M2, M3, M4 are taken into account in a group G1, only group models M1, M2, M3 can be included in a group G2 because model M4 differs too greatly from the other models M1, M2, M3, i.e., is not similar enough. Hence, a common group model MG2 of group G2 is more accurate.

Optionally, in some applications, model M4 could be taken into account with only a lower weighting than the weighting of models M1, M2, M3.

In other words, similar clients are grouped together in a cohort or group and collaborators are linked to similar, but also new, class designations.

This enables optimal performance when classifying anomalies frequently recorded in the group and is prepared to classify potential future anomalies already recorded by other clients.

Ignoring clients, i.e., group participants, such as group participants with the model M4, with very different class distributions ensures high accuracy for classifying the known anomalies in that no excessive distortion is introduced.

While the global model only has medium accuracy due to a heterogeneous class distribution, the group model has improved accuracy due to the aggregation of models within the same group and associated collaborators.

In other words, the global model aggregates all client models, while the group model selectively aggregates only the models of clients with the models M1, M2, M3 into a group model MG1.

The following figures show exemplary embodiments of the invention in the form of pseudocodes. Herein, a group is also designated a cohort. “Centroids” designates a center of a group.

FIG. 5 shows an exemplary embodiment of the invention in the form of pseudocode. This example shows a cohort-based FL process for improving the classification models when identifying anomalies.

A finite set of clients

Clients={c₁, c₂, . . . , cₙ}

is provided as an input set.

In line 5, the improved models ascertained for a specific cohort in regard of the anomaly classification are sent to the client, because client training for the cohort models of subsequent rounds is additionally requested. Therefore, the client can benefit from the improved models after each subsequent step.

In line 9, it may be identified that weightings are taken into account when forming the respective model (w).

By way of example, the quotient in the second term takes into account a proximity to a centroid of the respective cohort (w^{Coh})in order to incorporate more similar models to a greater degree than less similar models.

On the other hand, the illustrated algorithm could be modified because the iterative process is aborted when a predetermined desired accuracy or maximum accuracy is reached.

When new clients are added to the FL process, the cohort formation can also be executed there.

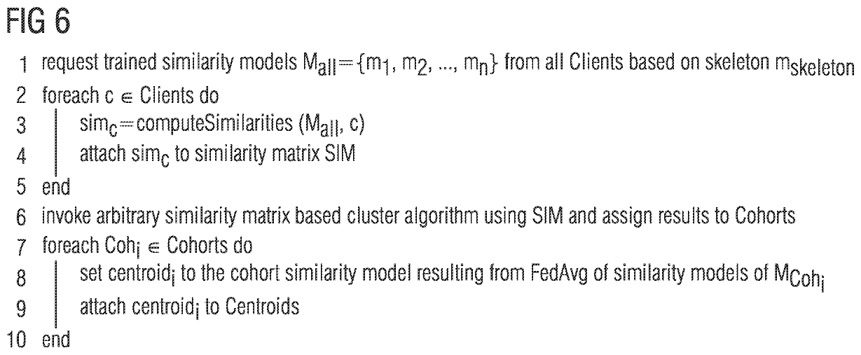

FIG. 6 shows an exemplary embodiment of the invention in the form of pseudocode for the formation of cohorts.

The pseudocode in FIG. 6 is called up by the pseudocode in FIG. 5 in order to instigate joint learning for multiple cohorts.

A finite set of clients

Clients={c₁, c₂, . . . , cₙ}

participating in the FL process is provided as an input set.

The algorithm provides a finite set of

Cohorts={Coh₁, Coh₂, . . . , Cohₖ}={(cₕ, . . . , cᵢ), (cⱼ, . . . , cₗ), . . . , (cₘ, . . . , cₙ)}

to clients as the output.

Furthermore, a finite set of centroids of aggregated similarity models is determined for all Centroids ∈ Cohorts.

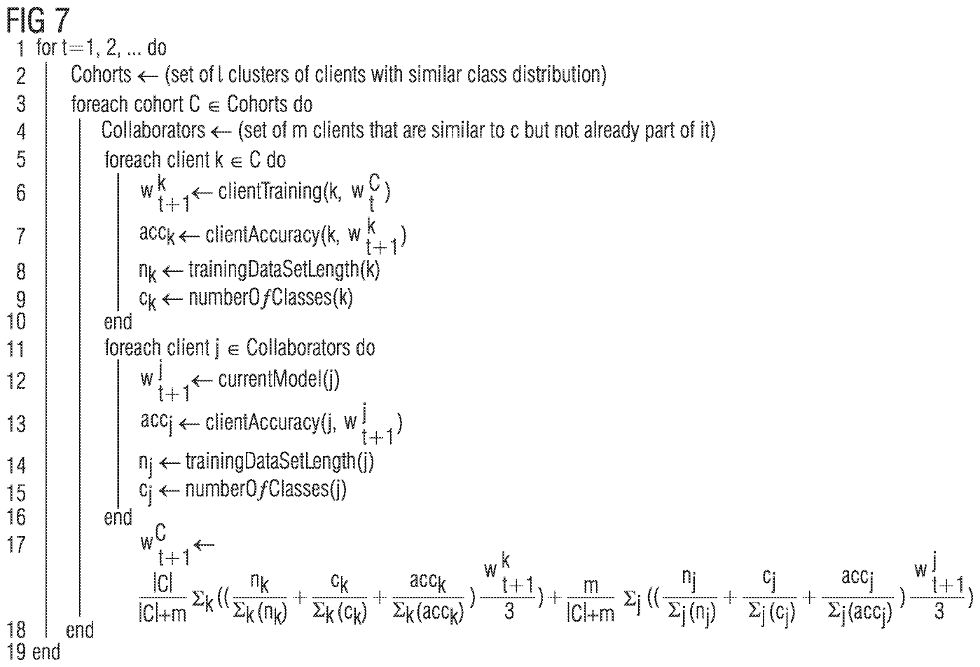

FIG. 7 is a schematic view of a further exemplary embodiment of the invention as pseudocode.

The behavior of an IFL server that executes global IFL cohort learning resulting in one global model per cohort C and time step t will now be explained in further detail.

At the start of each time step, the current cohort configuration is evaluated and possibly new clusters of clients with updated training data taken into account.

For each cohort, m collaborators are selected to introduce knowledge from clients with different class distributions.

The actual interaction with clients and collaborators occurs in the two inner loops to initiate training for client cohorts based on the current model.

In addition, it is also possible to acquire metrics, such as accuracy, length of the training dataset and number of classes.

These metrics are important for the aggregation of the model parameters for the group model in the next round t+1.

Unlike the case with conventional methods based on federated learning, the averaging of local client models in line 17 does not use the dataset length nₖ as a participation weight. Therefore, client models are also weighted with respect to the number of different classes cₖ and accuracy accₖ. This data is provided by the clients and thus allows good models, i.e., those with a correspondingly high accuracy, with many classes and the data is more likely to be weighted in the aggregated global group model wₜ₊₁^{c} in line 17.

In order to take into account the knowledge of collaborators, the second summand in line 17 shows the weighted input of m collaborator models.

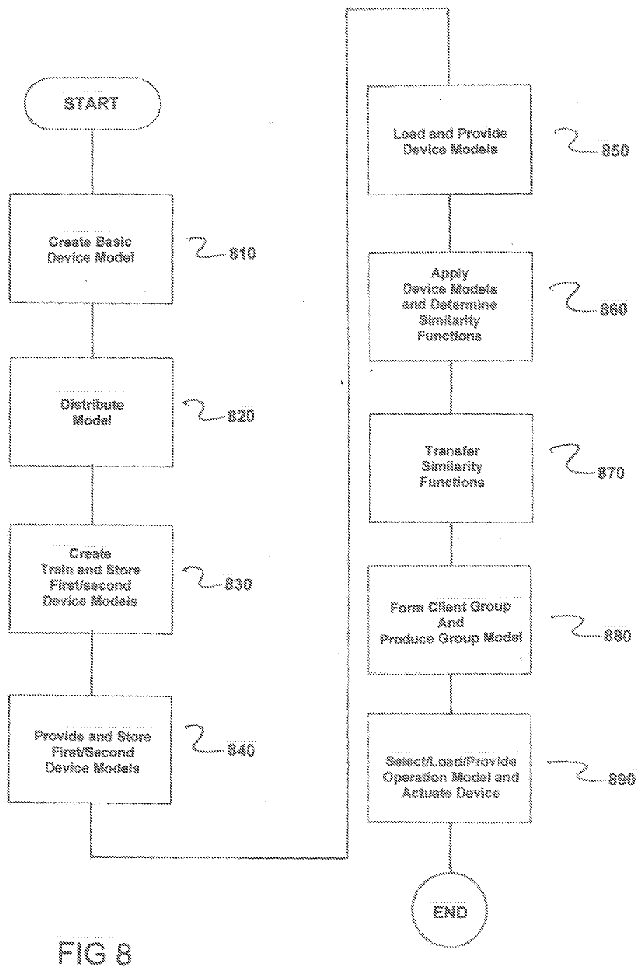

FIG. 8 is a flowchart of the method FIG. 8 is a flowchart of the method for operating a technical installation A1, A2, A with an optimal model, where the installation A1, A2, A3 forms part of a system S with a first technical installation Al and at least one second technical installation A2, A3, each installation A1, A2, A3 includes a control apparatus 15, 16, 17 with a memory and a connected technical device 25, 26, 27 and where the system further includes a server FLS1 with a memory MEM.

The method comprises creating a basic device model MB with respect to at least one of the technical devices 25, 26, 27, as indicated in step 810.

Next, the created basic device model MB is distributed to the first and the at least one second control apparatus 15, 16, 17, as indicated in step 820.

Next, a first device model MS1 is created, trained and stored by the first control apparatus 15 and at least one second device model MS2, MS3 is trained created and stored by the at least one second control apparatus 16, 17, in each case based on the created basic device model MB, as indicated in step 830.

Next, the first and the at least one second device model MS1, MS2, MS3 are provided to the server FLS1 and the first and the at least one second device model MS1, MS2, MS3 are stored in a model memory MEM of the server (FLS1, as indicated in step 840.

Next, at least those device models MS2, MS3 that are not already present in the control apparatus 15 are loaded and provided to the corresponding control apparatus 15, as indicated in step 850.

Next, the device models MS2, MS3 provided in step 850 are applied to the respective control apparatus 15 and a respective similarity function SF1_2, SF1_3 is determined with respect to the first control apparatus 15 and the first similarity model MS1, MS3 to the at least one second control apparatus 16, 17 and a respective similarity function SF2_1, SF2_3, SF_3_1, SF3_2 is determined with respect to the at least one second control apparatus 16, 17, as indicated in step 860.

Next, respective similarity functions SF1_2, SF1_3, SF2_1, SF2_3, SF_3_1, SF3_2 are transferred to the server FLS1, as indicated in step 870.

Next, at least one client group is formed and a respective group model MG1, M2, MG3 is produced by federated learning within the client group by applying the respective similarity functions SF1_2, SF1_3, SF2_1, SF2_3, SF 3_1, SF3_2 by the server FLS1, as indicated in step 880.

Next, an operation model M01 is selected and loaded from the at least one group model MG1 for an installation Al and the operation model M01 is provided to the control apparatus 15 thereof, and the device 25 is utilized to actuate the selected operation model M01 as the optimal model, as indicated in step 890.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

### LIST OF REFERENCE CHARACTERS

1 Network
5-7 Local network
10-12, 15-17 Control apparatus, edge device
20-22, 25-27 IoT device, technical device, asset
FLS, FLS1 Model server
FLM, FLM1 Group manager
G1, G2 Group
A1-A3 Installation
S System
M0, MB Base model
M01 Operation model
MC1-MC3 Centroid model
MG, MG1, MG2 Group model
M1-M4, MS1-MS3 Similarity model
MES Production system: manufacturing execution system
ERP Resource planning system: enterprise resource planning
P1-P9, Q1-09,
R1-R7 Process steps
P1 Editing data
P2 Anomaly detection
P3 Device control
P3a Stop/reduce
P3b Alarm
P3c Reschedule production
P3d Order spare part
P4 Modeling and evaluating metrics
P5 Distributing models and data
P6 Group configuration
P7 Updating aggregates
P8 Model update
P9 Renewed training with updated models
Q1 Creation of a basic device model MG
Q2 Distributing the basic device model MG to edge apparatuses
Q3 Creating and training on the basis of the basic device model MB of device models by the edge apparatuses
Q4 Providing the device models MS1-MS3 to an IFL server FLS1 and storing.
Q5 Loading and providing the similarity models to edge apparatuses
Q6 Applying the similarity models to edge apparatus and determining similarity functions or similarity values
Q7 Transferring the similarity functions or the similarity values to the IFL server.
Q7a Calculating centroid model
Q7b Storing the similarity functions or the similarity values in a similarity matrix SIM
Q8 Forming model groups
Q9 Actuating the device with operation model
R1 Receiving a basic device model
R2 Creating, training and storing a first device model
R3 Providing the device model
R4 Receiving a second device model
R5 Applying the second device model and determining a similarity function or similarity value
R6 Providing the similarity function or the similarity value
R7 Receiving an operation model

What is claimed is:

1. A method for operating a technical installation with an optimal model, the installation forming part of a system with a first technical installation and at least one second technical installation, each installation including a control apparatus with a memory and a connected technical device and the system further comprising a server with a memory, the method comprising:
Q1) creating a basic device model with respect to at least one of the technical devices;
Q2) distributing the created basic device model to the first and the at least one second control apparatus;
Q3) creating, training and storing a first device model by the first control apparatus and at least one second device model by the at least one second control apparatus, in each case based on the created basic device model;
Q4) providing the first and the at least one second device model to the server and storing the first and the at least one second device model in a model memory of the server;
Q5) loading and providing at least those device models which are not already present in the control apparatus to the corresponding control apparatus;
Q6) applying the device models provided in said loading and providing of Q5) to the respective control apparatus and determining a respective similarity function with respect to the first control apparatus and the first similarity model to the at least one second control apparatus and determining a respective similarity function with respect to the at least one second control apparatus;
Q7) transferring respective similarity functions to the server;
Q8) forming at least one client group and producing a respective group model by federated learning within the client group by applying the respective similarity functions by the server; and
Q9) selecting and loading an operation model from the at least one group model for an installation and providing the operation model to the control apparatus thereof and actuating the device utilizing the selected operation model as the optimal model.

2. The method as claimed in claim 1, after executing said transferring of Q7), further comprising:
Q7a) calculating at least one centroid model based on a federated averaging method using the similarity functions and taking into account at least one centroid model when forming at least one group model during said forming of Q8).

3. The method as claimed in claim 1, after executing said transferring of Q7), the method a further comprising:
Q7b) storing the similarity functions in a similarity matrix.

4. The method as claimed in claim 1, wherein at least one weighting function is applied when forming the at least one group model during said forming of Q8).

5. The method as claimed in claim 1, wherein the basic device model is created by the server.

6. The method as claimed in claim 1, wherein the installation is connected to the control apparatus via a local network and connected to the server via a public network.

7. The method as claimed in claim 1, wherein the at least one second installation is in each case connected to the respective control apparatus via a local network and in each case is connected to the server via a public network.

8. A system for operating a technical installation with an optimal model, comprising:
a first technical installation; and
at least one second technical installation, each installation including a control apparatus with a memory and a technical device; and
a server with a memory;
wherein the system is configured to:
Q1) create a basic device model with respect to at least one of the technical devices;
Q2) distribute the created basic device model to the first and the at least one second control apparatus;
Q3) create, train and store a first device model by the first control apparatus and at least one second device model by the at least one second control apparatus, in each case based on the created basic device model;
Q4) provide the first and the at least one second device model to the server and store the first and the at least one second device model in a model memory of the server;
Q5) load and provide at least those device models which are not already present in the control apparatus to the corresponding control apparatus (15);
Q6) apply the device models provided in said loading and providing of Q5) to the respective control apparatus and determine a respective similarity function with respect to the first control apparatus and the first similarity model to the at least one second control apparatus and determine a respective similarity function with respect to the at least one second control apparatus;
Q7) transfer respective similarity functions to the server;
Q8) form at least one client group and produce a respective group model by federated learning within the client group by applying the respective similarity functions by the server; and
Q9) select and load an operation model from the at least one group model for an installation and providing the operation model to the control apparatus thereof and actuate the device utilizing the selected operation model as the optimal model.

9. An installation for operation with an optimal model, the installation comprising:
a control apparatus with a memory; and
a technical device;
wherein the control apparatus is configured to:
R1) receive a basic device model;
R2) create, train and store a first device model based on the received basic device model;
R3) provide the first device model via a first data interface;
R4) receive at least one second device model which is not already present in the control apparatus via a second data interface;
R5) apply the at least one second device model received during R4) to the control apparatus and determine at least one similarity function with respect to the first device model;
R6) provide the at least one similarity function via a third data interface; and
R7) receive an operation model which was formed by at least one group model by applying the at least one similarity function via a fourth data interface, and actuate the device utilizing the operation model as the optimal model.

10. The installation as claimed in the preceding claim 9, wherein the at least one of the first, second, third and data interface is formed by a public network and the installation is connected to the control apparatus via a local network.
